(19) United States
(12) Patent Application Publication
(10) Pub. No.: US 2025/0111618 A1
(43) Pub. Date: Apr. 3, 2025

(54) SYSTEM AND METHOD FOR GENERATING VISUAL CONTENT

(71) Applicant: Territory Studio (Holdings) Limited, London (GB)

(72) Inventors: Gerard Rallo, Barcelona (ES); Marti Romances, San Francisco, CA (US)

(21) Appl. No.: 18/375,647

(22) Filed: Oct. 2, 2023

(51) Int. Cl. G06T 19/00; G06T 7/80; G06T 15/20

(52) U.S. Cl. CPC G06T 19/006; G06T 7/80; G06T 15/205; G06T 2200/24; G06T 2207/10016; G06T 2207/30244; G06T 2215/16

(57) ABSTRACT

The present disclosure relates to a system for generating visual content, the system comprising: a video camera; an interactive display screen configured to display visual content, wherein the interactive display screen is within a field of view of the video camera; and one or more processors configured to: receive video camera position and/or orientation data indicative of a viewpoint of the video camera; and generate, for display on the interactive display screen, a three-dimensional projection image based on the video camera position and/or orientation data, such that the three-dimensional projection image shows a three-dimensional content item from the viewpoint of the video camera.

### FIELD

The present disclosure relates to a system and a method for generating visual content, and in particular for generating visual content for display on a display screen within a field of view of a video camera.

### BACKGROUND

Video content such as films, television programmes and news broadcasts often feature graphics displayed on a screen within the field of view of a video camera. For example, an actor may interact with a screen or user interface in a particular scene of a film, or a news presenter may interact with an on-set screen showing graphics that are relevant to a particular news item. Such screens within the video camera field of view can display two-dimensional content.

Visual effects and post-production methods can be utilised in order to give the impression that a user is viewing or even interacting with three-dimensional content on a screen. Visual effects and post-production methods can even be utilised to alter the three-dimensional content displayed on the screen when the video camera view changes. Examples of such methods include match moving and rotoscoping.

However, such methods are typically laborious, time consuming and expensive. When a visual effect is added in post-production, an actor may struggle to get an appreciation for how the three-dimensional content item will ultimately look to the audience, and so they cannot adapt their performance to take this into account. In addition, it will be appreciated that post-production methods are unsuitable for live broadcasts.

Accordingly, there exists a need for systems and methods that allow for the display of more advanced on-screen graphics within video content, in a fast and efficient manner.

### SUMMARY

This summary introduces concepts that are described in more detail in the detailed description. It should not be used to identify essential features of the claimed subject matter, nor to limit the scope of the claimed subject matter.

According to a first aspect of the present disclosure, there is provided a system for generating visual content, the system comprising: a video camera; an interactive display screen configured to display visual content, wherein the interactive display screen is within a field of view of the video camera; and one or more processors configured to: receive video camera position and/or orientation data indicative of a viewpoint of the video camera; and generate, for display on the interactive display screen, a three-dimensional projection image based on the video camera position and/or orientation data, such that the three-dimensional projection image shows a three-dimensional content item from the viewpoint of the video camera.

By generating a three-dimensional projection image based on position and/or orientation data of a video camera, a three-dimensional projection image can be displayed on a display screen in real-time, while the video camera is being used to record video of a scene that comprises the display screen. Accordingly, the display screen within the field of view of the video camera displays visual content (i.e. a three-dimensional projection image showing a three-dimensional content item from a viewpoint of the video camera). This means that three-dimensional content displayed on the screen does not need to be added or altered using visual effects and post-production methods.

Accordingly, visual content and on-screen graphics can be displayed on a display screen in a faster and more efficient manner than in systems that utilise visual effects and post-production. In addition, the ability to display a three-dimensional projection image in real-time allows the system to be used for recording live broadcasts, for which visual effects and post-production methods are unsuitable. Moreover, the display of a three-dimensional projection image on a display screen during recording means that a user (such as an actor or presenter) can interact with the visual content that is displayed on the display screen, rather than interacting with a green screen. The interaction of a user with the visual content on the display screen means that user interaction with the display screen is simplified (as the user does not need to guess the locations of content items), and the user's actions appear more realistic. Also, a further advantage over green screen is that light emitted by the display screen showing the visual content is cast over the user's hands, faces, etc. and around the set, thereby providing a more realistic view of a user's interaction with the visual content.

Generating the three-dimensional projection image based on the video camera position and/or orientation data may comprise determining relative position and/or orientation data indicative of a position and/or an orientation of the video camera relative to a position and/or an orientation of the interactive display screen.

The system may further comprise a video camera tracking module configured to track a position and/or an orientation of the video camera, wherein the one or more processors receive the video camera position and/or orientation data from the video camera tracking module.

The viewpoint may be a first viewpoint and the video camera position and/or orientation data may be first video camera position and/or orientation data, and the one or more processors may further be configured to: receive second video camera position and/or orientation data indicative of a second viewpoint different to the first viewpoint; and generate, for display on the interactive display screen, an updated three-dimensional projection image based on the second video camera position and/or orientation data, such that the updated three-dimensional projection image shows the three-dimensional content item from the second viewpoint.

The second video camera position and/or orientation data may be indicative of an updated viewpoint of the video camera.

The video camera may be a first video camera, and the system may further comprise a second video camera different to the first video camera, wherein the interactive display screen is within a field of view of the second video camera; wherein the second video camera position and/or orientation data is indicative of a viewpoint of the second video camera; and wherein the one or more processors are configured to generate the updated three-dimensional projection image in response to receiving an indication that the interactive display screen is to be viewed from the viewpoint of the second video camera.

Accordingly, the three-dimensional projection image can be updated to account for movement of the video camera or use of a different video camera with a different viewpoint.

The interactive display screen may be a first display screen, and the three-dimensional projection image may be a first three-dimensional projection image, and the system may further comprise a second display screen configured to display visual content, wherein the second display screen is within the field of view of the video camera; and wherein the one or more processors are further configured to generate, for display on the second display screen, a second three-dimensional projection image based on the video camera position and/or orientation data. The system can therefore cater for more complex sets in which multiple display screens are utilised.

The second display screen may be configured to display second visual content, wherein the second visual content is independent of the first visual content displayed on the first display screen. The second three-dimensional projection image may show the first three-dimensional content item from the viewpoint of the video camera. Alternatively, the second three-dimensional projection image may show a second three-dimensional content item from the viewpoint of the video camera, wherein the second three-dimensional content item is different to the first three-dimensional content item. The second display screen may be interactive.

The one or more processors may further be configured to: receive display screen position and/or orientation data indicative of a position and/or an orientation of the interactive display screen; and generate the three-dimensional projection image based on the video camera position and/or orientation data and the display screen position and/or orientation data.

The system may further comprise a display screen tracking module configured to track the position and/or the orientation of the interactive display screen, wherein the one or more processors receive the display screen position and/or orientation data from the display screen tracking module.

The system may further comprise: a first computing device comprising a first one of the one or more processors, wherein the first one of the one or more processors is configured to receive the video camera position and/or orientation data; and a second computing device comprising a second one of the one or more processors, wherein the second computing device is in communication with the first computing device over a network, and wherein the second one of the one of more processors is configured to: receive the video camera position and/or orientation data from the first computing device over the network; and generate, for display on the interactive display screen, the three-dimensional projection image.

The use of the first computing device that receives the video camera position and/or orientation data increases the scalability of the system for generating visual content, by increasing the number of display screens that can be implemented in the system. In addition, scalability is increased because the use of the first computing device that receives the video camera position and/or orientation allows the second computing device to be agnostic to the tracking technology used to track the position and/or orientation of the video camera, thereby increasing the amount of display screens and the type of display screens that can be used in the system.

The second computing device may comprise the interactive display screen.

The one or more processors may be configured to: receive a user interaction with the three-dimensional content item; and adjust the display of the three-dimensional projection image based on the user interaction. The user interaction may comprise moving the display screen from a first position and/or orientation to a second position and/or orientation. The user interaction may be received via the display screen.

According to a second aspect of the present disclosure, there is provided a method of generating visual content, the method comprising: receiving video camera position and/or orientation data indicative of a viewpoint of a video camera; and generating, for display on an interactive display screen within a field of view of the video camera, a three-dimensional projection image based on the video camera position and/or orientation data, such that the three-dimensional projection image shows a three-dimensional content item from the viewpoint of the video camera.

Generating the three-dimensional projection image based on the video camera position and/or orientation data may comprise determining relative position and/or orientation data indicative of a position and/or an orientation of the video camera relative to a position and/or an orientation of the interactive display screen.

The viewpoint may be a first viewpoint and the video camera position and/or orientation data may be first video camera position and/or orientation data, and the method may further comprise: receiving second video camera position and/or orientation data indicative of a second viewpoint different to the first viewpoint; and generating, for display on the interactive display screen, an updated three-dimensional projection image based on the second video camera position and/or orientation data, such that the updated three-dimensional projection image shows the three-dimensional content item from the second viewpoint.

The second video camera position and/or orientation data may be indicative of an updated viewpoint of the video camera.

The video camera may be a first video camera; the second video camera position and/or orientation data may be indicative of a viewpoint of a second video camera different to the first video camera, wherein the interactive display screen is within a field of view of the second video camera; and the updated three-dimensional projection image may be generated in response to receiving an indication that the interactive display screen is to be viewed from the viewpoint of the second video camera.

The interactive display screen may be a first display screen, and the three-dimensional projection image may be a first three-dimensional projection image; and the method may further comprise: generating, for display on a second display screen within the field of view of the video camera, a second three-dimensional projection image based on the video camera position and/or orientation data. The second display screen may be configured to display second visual content, wherein the second visual content is independent of the first visual content displayed on the first display screen. The second three-dimensional projection image may show the first three-dimensional content item from the viewpoint of the video camera. Alternatively, the second three-dimensional projection image may show a second three-dimensional content item from the viewpoint of the video camera, wherein the second three-dimensional content item is different to the first three-dimensional content item. The second display screen may be interactive.

The method may further comprise: receiving display screen position and/or orientation data indicative of a position and/or an orientation of the interactive display screen; and generating the three-dimensional projection image based on the video camera position and/or orientation data and the display screen position and/or orientation data.

The method may further comprise: receiving a user interaction with the three-dimensional content item; and adjusting the display of the three-dimensional projection image based on the user interaction. The user interaction may comprise moving the display screen from a first position and/or orientation to a second position and/or orientation. The user interaction may be received via the display screen.

According to a third aspect of the present disclosure, there is provided a computer-readable medium comprising instructions which, when executed by one or more processors of a computing device, cause the computing device to carry out the method of the second aspect.

### BRIEF DESCRIPTION OF FIGURES

Specific embodiments are described below by way of example only and with reference to the accompanying drawings, in which:

FIG. 1A shows a schematic diagram of a video recording system according to a first example.

FIG. 1B shows a schematic diagram of modules of a tracking and visualisation computing device according to the first example.

FIG. 2 shows a schematic diagram of a video recording system according to a second example.

FIG. 3A shows a schematic diagram of a video recording system according to a third example.

FIG. 3B shows a schematic diagram of modules of a tracking master computing device and modules of a visualisation computing device according to the third example.

FIG. 4 shows a schematic diagram of a video recording system according to a fourth example.

FIG. 5 shows a flowchart of a method of generating visual content.

FIG. 6 shows a schematic diagram of a computing device configured to implement the methods of the present disclosure.

### DETAILED DESCRIPTION

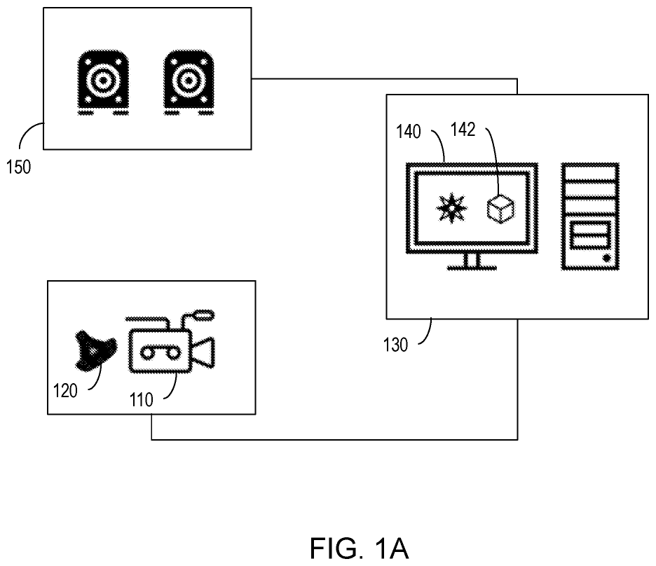

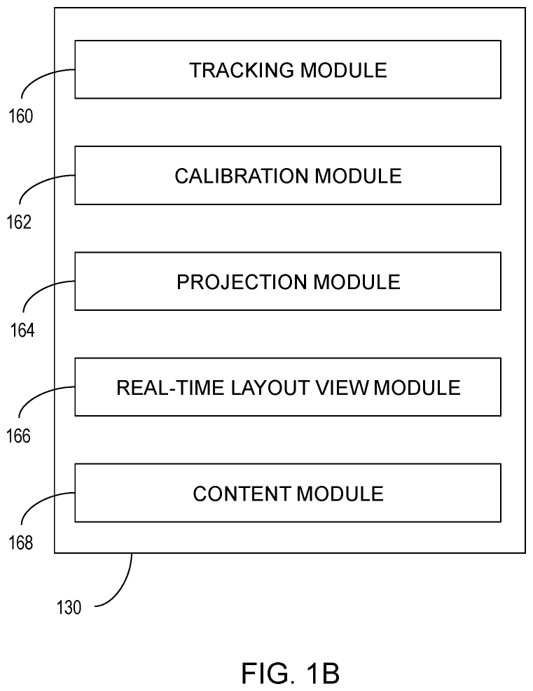

FIG. 1A shows a schematic diagram of a video recording system 100 according to a first example. The video recording system 100 may be located in any environment in which video content is recorded, including, for example, a film set or a television studio. The video recording system 100 may be used to record live video (e.g. live news broadcasts), or to record video content such as films or television programmes.

As shown in FIG. 1A, the video recording system 100 includes a video camera 110. The video camera 110 can be moved around relative to other components of the video recording system 100 (in particular, relative to an interactive display screen 140, described in more detail below). The position and orientation of the video camera 110 is tracked using a video camera tracking device 120, such as a VIVE Tracker available from HTC of Xindian, Taiwan, which is configured to transmit video camera position and orientation data describing the position and orientation of the video camera 110.

The video recording system 100 also includes a tracking and visualisation computing device 130 comprising one or more processors. The tracking and visualisation computing device 130 receives position and orientation data relating to the position and orientation of the video camera 110 from the video camera tracking device 120. The tracking and visualisation computing device 130 is associated with an interactive display screen 140, which is configured to display visual content. In one example, the tracking and visualisation computing device 130 comprises the interactive display screen 140.

As used herein, the term “interactive” means that a user who is viewing the display screen can provide a form of input to the display screen, and that the visual content displayed by the display screen is updated in response to the user's input, meaning that the user sees different visual content to that displayed on the display screen prior to providing their input. In one example, the display screen may be a touchscreen display screen, and the user input may provide their input by means of a touch input to the touchscreen display screen.

In some examples, the display screen 140 is present in the foreground of a field of view of the video camera 110. As used herein, the term “foreground” indicates that the distance between the video camera 110 and the display screen 140 is less than the distance between the video camera 110 and at least one other object within the field of view of the video camera 110. In one example, the display screen 140 may be located such that an individual (e.g. an actor or a presenter) may move behind the display screen 140 and optionally in front of the display screen 140, when viewed from the field of view of the video camera 110.

The display screen 140 may be, for example, a display screen of a desktop PC (e.g. computer monitor), laptop, tablet, smartphone, television, video wall, or any other device that displays visual content, or may be a projection screen on which visual content is displayed using a video projector. The display screen 140 may be, for example, an LCD, LED, QLED or OLED display.

The video recording system 100 also includes one or more light stations 150 (e.g. infrared emitters) that provide static reference points for the video camera tracking device 120, so that the video camera tracking device 120 can determine its position and orientation (and thereby the position and orientation of the video camera 110 that it is tracking). For example, for an implementation of the video recording system 100 that uses a VIVE tracking system, the video recording system 100 includes at least two light stations 150. It will be appreciated that, in alternative examples, the one or more light stations 150 may not be required in order for the video camera tracking device 120 to determine its position and orientation. For example, some video camera tracking devices 120 may use internal cameras and/or other technologies to determine their position and orientation (such as a self-tracking VIVE tracker available from HTC of Xindian, Taiwan).

The display screen 140 displays interactive video content. Specifically, the display screen 140 is configured to display a three-dimensional projection image 142 depicting a three-dimensional content item from a particular viewpoint. This allows the depth of the three-dimensional content item to be appreciated by a viewer of the display screen 140. Three-dimensional projection images therefore allow for the display of more complex computer graphics, and enhance the display of a content item on a display screen to provide additional detail and/or additional realism, when compared with a two-dimensional image of the content item.

The one or more processors of the tracking and visualisation computing device 130 receive the position and orientation data of the video camera 110 from the video camera tracking device 120. The one or more processors may be, for example, one or more graphics processing units (GPUs) of the tracking and visualisation computing device 130. The one or more processors then use the received position and orientation data to generate (i.e. render) a three-dimensional projection image 142 for display on the display screen 140. Specifically, the one or more processors render the three-dimensional projection image 142 based on the position and orientation data of the video camera 110, so that the three-dimensional projection image 142 shows a three-dimensional content item from the viewpoint of the video camera 110.

For example, when the video camera 110 is located near a surface normal of the display screen 140 and the display screen 140 is near the centre of the field of view of the video camera 110, the depth component of the three-dimensional projection image 142 will occupy a relatively small area of the display screen 140 (because the three-dimensional content item is being viewed ‘front on’). As the video camera 110 is moved so that the display screen 140 is nearer the edge of the field of view of the video camera 110 (assuming, in this case, that the display screen 140 is static), the area of the display screen 140 occupied by the depth component of the three-dimensional projection image 142 will increase, because the three-dimensional content item is being viewed from the video camera 110 at a shallower angle.

Similarly, if the video camera 110 is moved so that it is further from a surface normal of the display screen 140 (e.g. by increasing the angle of an imaginary line between the video camera 110 and the display screen 140 to a surface normal of the display screen 140), the depth component of the three-dimensional projection image 142 will also occupy a greater area of the display screen 140, because the three-dimensional content item is again being viewed from the video camera 110 at a shallower angle.

To generate the three-dimensional projection image 142 based on the position and orientation data of the video camera 110, the one or more processors of the tracking and visualisation computing device 130 determine the position and orientation of the video camera 110 relative to the position and orientation of the display screen 140. In some examples (e.g. as described further below), the position and orientation of the display screen 140 may be tracked using a tracking device (e.g. in the same way as the position and orientation of the video camera 110 is tracked). In other examples, the display screen 140 may have a fixed position and orientation, which may be input to the tracking and visualisation computing device 130 (e.g. by a user, or through a calibration system that uses an independent tracking device to initialize the position of the display screen 140).

Where there is an offset between the position of the video camera tracking device 120 and the video camera 110, that offset may be provided to the tracking and visualisation computing device 130 so that it can account for the offset when generating the three-dimensional projection image 142. For example, any offset may be measured during setup of the video recording system 100, and input to the one or more processors of the tracking and visualisation computing device 130.

As indicated above, the video camera 110 can be moved around relative to the display screen 140. Moving the video camera 110 changes the viewpoint (i.e. position and/or orientation) of the video camera 110 relative to the display screen 140. When the video camera 110 moves to a different viewpoint relative to the display screen 140, updated position and/or orientation data is sent to the tracking and visualisation computing device 130 from the video camera tracking device 120. Position and orientation data may be sent to the tracking and visualisation computing device 130 from the video camera tracking device 120 in response to the video camera tracking device 120 detecting movement of the video camera 110 (e.g. using one or more gyroscopes and/or accelerometers), or may be sent to the tracking and visualisation computing device 130 periodically (e.g. every frame, or every few milliseconds).

Upon receipt of updated position and/or orientation data indicating that the viewpoint of the video camera 110 relative to the display screen 140 has changed, the one or more processors generate an updated three-dimensional projection image. The updated three-dimensional projection image is based on the updated position and/or orientation data received from the video camera tracking device 120, and is generated so that it shows the three-dimensional content item from the updated viewpoint of the video camera 110.

A user, such as an actor or news presenter, may interact with the three-dimensional content item displayed on the display screen 140. For example, the display screen 140 may be a touchscreen and the user may provide a touch gesture such as a swipe, press, pinch in, or pinch out gesture, in order to move, select, rotate, zoom in on, or zoom out from the current display of the three-dimensional content item. As another example, the user may provide a touch gesture (e.g. press, swipe) that causes a transition from a display of the three-dimensional content item to a display of a different three-dimensional content item. As a further example, the three-dimensional content item may be in the form of a user interface with menu options that the user can select, whereby selection of a particular option causes the display of a further user interface or content item. It will be appreciated that the user input is not limited to touch input, and may be received in other ways, such as via a user input device such as a keyboard, mouse, or button press, or as a voice or gesture-based input.

In response to receiving the user interaction with the three-dimensional content item, the one or more processors adjust the display of the three-dimensional projection image 142 based on the user interaction. Adjusting the display of the three-dimensional projection image 142 may include, for example, rendering a panned, rotated, zoomed in or zoomed out view of the three-dimensional content item; ceasing the display of the current three-dimensional content item and rendering a new three-dimensional projection image showing a different three-dimensional content item; or displaying a menu or other content item associated with the three-dimensional content item currently being displayed.

FIG. 1B is a schematic diagram showing the modules of the tracking and visualisation computing device 130. As shown in FIG. 1B, the tracking and visualisation computing device 130 comprises a tracking module 160, a calibration module 162, a projection module 164, a real-time layout view module 166, and a content module 168.

The tracking module 160 receives the position and orientation data from the video camera tracking device 120.

The calibration module 162 allows for calibration of the video recording system 100. For example, the calibration module 162 allows for the position and orientation of any static display screens (e.g. the display screen 140 shown in FIG. 1) to be input during setup of the video recording system 100. The position and orientation of static display screens may be input relative to origin coordinates of the video recording system 100. The origin of the video recording system 100 can be initialised using the calibration module 162 by placing a tracking device (e.g. the video camera tracking device 120) at a point in the three-dimensional environment that is intended to be used as the origin. Once the origin has been initialised and saved, the tracking device can be used for tracking another object in the video recording system 100, such as the video camera 110.

In this example, the calibration module 162 also allows data relating to the display screen 140 to be input during setup of the video recording system 100. For example, the calibration module 162 may receive data identifying the size of the display screen 140, the position and orientation of the display screen 140 within the three-dimensional environment, a unique identifier of the display screen 140, and an indicator that indicates whether the display screen 140 is static (as with the example of FIG. 1) or movable (as described in examples below). This data may be input to the calibration module 162 (e.g. via a user interface) or received over a network.

The projection module 164 computes a projection matrix used to render the three-dimensional projection image 142 based on the position and orientation of the video camera 110, the position and orientation of the display screen 140, and the settings of the display screen 140 (e.g. dimensions, etc.). The projection matrix may be recomputed every frame so that the three-dimensional projection image 142 is consistent with the video recorded by the video camera 110.

The real-time layout view module 166 provides a view of the video recording system 100 so that the locations of the video cameras and display screens (in this example, the video camera 110 and the display screen 140) can be seen in real-time. The visualisation of the video recording system 100 provided by the real-time layout view module 166 allows for easier setup and debugging of the video recording system 100.

The content module 168 allows three-dimensional content items to be generated for display on the display screen 140. For example, the content module 168 may store data describing the three-dimensional content items that are to be displayed on the display screen 140. Such data may include shape, size, orientation and colour information, along with any text information that is to be displayed with the content item. More generally, the content module 168 may include any kind of logic that generates procedural content and animations (e.g. the three-dimensional content items) in real-time. The projection module 164 applies the projection matrix to a three-dimensional content item provided by the content module 168 in order to render the three-dimensional projection image 142 for display on the display screen 140.

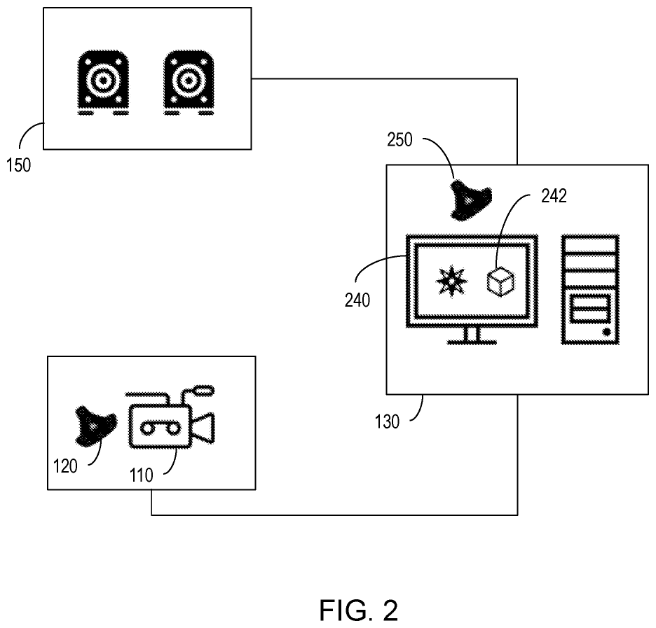

FIG. 2 is a schematic diagram of a video recording system 200 according to a second example. The video recording system 200 of the second example includes the video camera 110, video camera tracking device 120, tracking and visualisation computing device 130 and light stations 150 described above for the video recording system 100 of the first example. However, in the video recording system 200 according to the second example, the display screen is a movable display screen 240 that is within a field of view of the video camera 110. The display screen 240 can therefore be moved from an initial position and orientation to a different position and/or orientation.

To cater for the movement of the display screen 240, the video recording system 200 also includes a display screen tracking device 250. The display screen tracking device 250 is configured to track the position and orientation of the display screen 240, for example in the same way that the video camera tracking device 120 tracks the position and orientation of the video camera 110.

In the video recording system 200 shown in FIG. 2, the one or more processors of the tracking and visualisation computing device 130 receive position and orientation data describing the position and orientation of the video camera 110, as well as position and orientation data describing the position and orientation of the display screen 240. The one or more processors then generate a three-dimensional projection image 242 for display on the display screen 240 based on the video camera position and orientation data and the display screen position and orientation data. The three-dimensional projection image 242 is generated so that it shows a three-dimensional content item from the viewpoint of the video camera 110.

Generating the three-dimensional projection image 242 may involve the one or more processors determining a relative position and/or orientation of the video camera 110 relative to the display screen 240. Alternatively, the video camera tracking device 110 may provide the position and orientation of the video camera 110 relative to the position and orientation of the display screen 240.

As with the video recording system 100 shown in FIG. 1A, the one or more processors of the video recording system 200 may receive updated video camera position and/or orientation data describing an updated viewpoint of the video camera 110, and may update the display of the three-dimensional projection image 242 so that it shows the three-dimensional content item from the updated viewpoint of the video camera 110.

In addition, the one or more processors of the video recording system 200 may receive updated display screen position and/or orientation data, describing an updated position and/or orientation of the display screen 240. Upon receipt of updated display screen position and/or orientation data, the one or more processors of the tracking and visualisation computing device 130 update the display of the three-dimensional projection image 242 so that it shows the three-dimensional content item from the viewpoint of the video camera 110 relative to the new position and/or orientation of the display screen 240.

As explained above in relation to FIG. 1A, a user may interact with a three-dimensional content item displayed on interactive display screen in a number of different ways. In addition to the interactions listed above for the static interactive display screen 140 of the first example, a user may interact with the three-dimensional content item displayed on the movable display screen 240 of the second example by moving the display screen 240 to a different position and/or orientation within the field of view of the video camera 110. For example, a user may carry the display screen 240 from a first location to a second location, or may tilt or rotate the display screen 240 in order to view the three-dimensional content item from a different perspective. Consequently, the one or more processors may adjust the display of the three-dimensional projection image 242 displayed on the movable display screen 240 based on a user interaction that comprises moving the movable display screen 240.

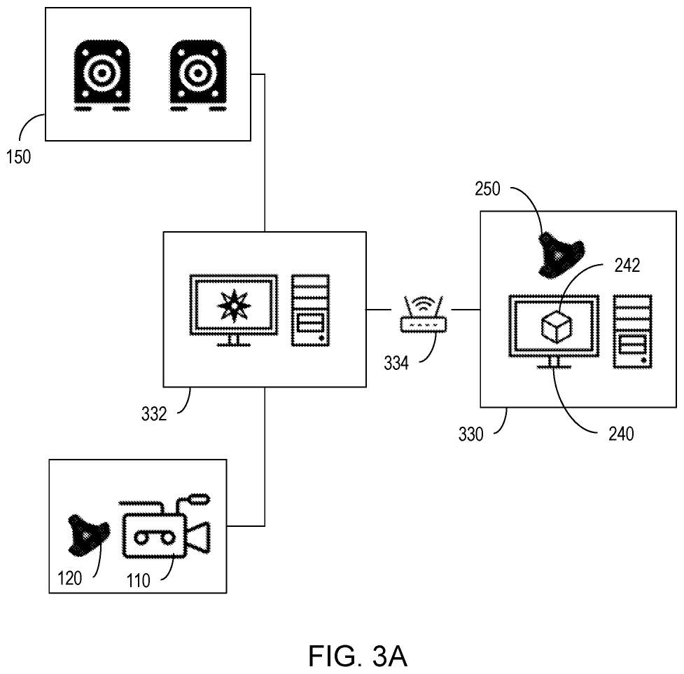

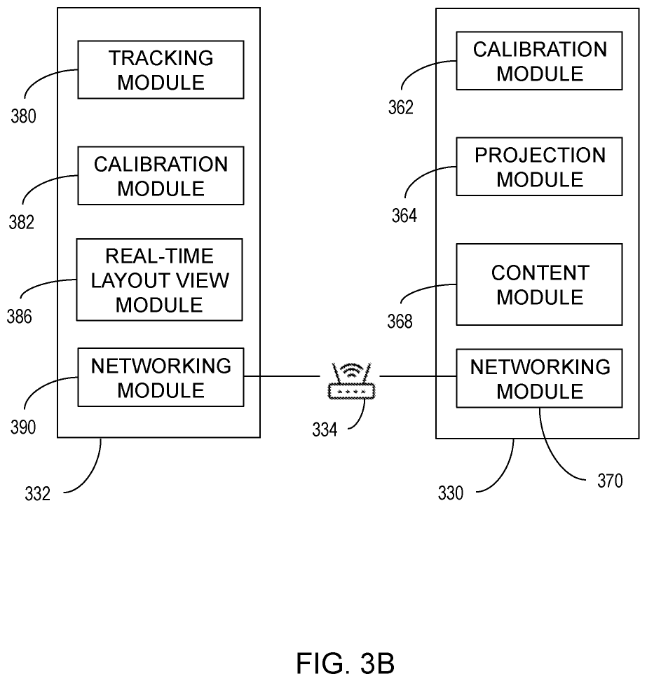

FIG. 3A is a schematic diagram of a video recording system 300 according to a third example. The video recording system 300 of the third example includes the video camera 110 and video camera tracking device 120 described above for the video camera recording system 100 of the first example, along with the movable interactive display screen 240 and display screen tracking device 250 described above for the video camera recording system 200 of the second example. However, instead of a tracking and visualisation computing device, the video camera recording system 300 includes a visualisation computing device 330 and a separate tracking master computing device 332. The tracking master computing device 332 communicates with the visualisation computing device 330 over a network 334.

The tracking master computing device 332 receives position and orientation data for all video cameras that are being tracked (e.g. all movable video cameras), and optionally for any display screens that are being tracked. Accordingly, in the example shown in FIG. 3A, the tracking master computing device 332 receives video camera position and orientation data from the video camera tracking device 120, and optionally display screen position and orientation data from the display screen tracking device 250.

In one example, the tracking master computing device 332 is configured to generate consolidated position and orientation data by generating a virtual representation of a scene. This virtual representation may include the relative position and orientation of all tracked devices in three-dimensional space, along with an identification (set during calibration of the tracking devices 120, 250) of whether each tracked device is a display screen or a video camera.

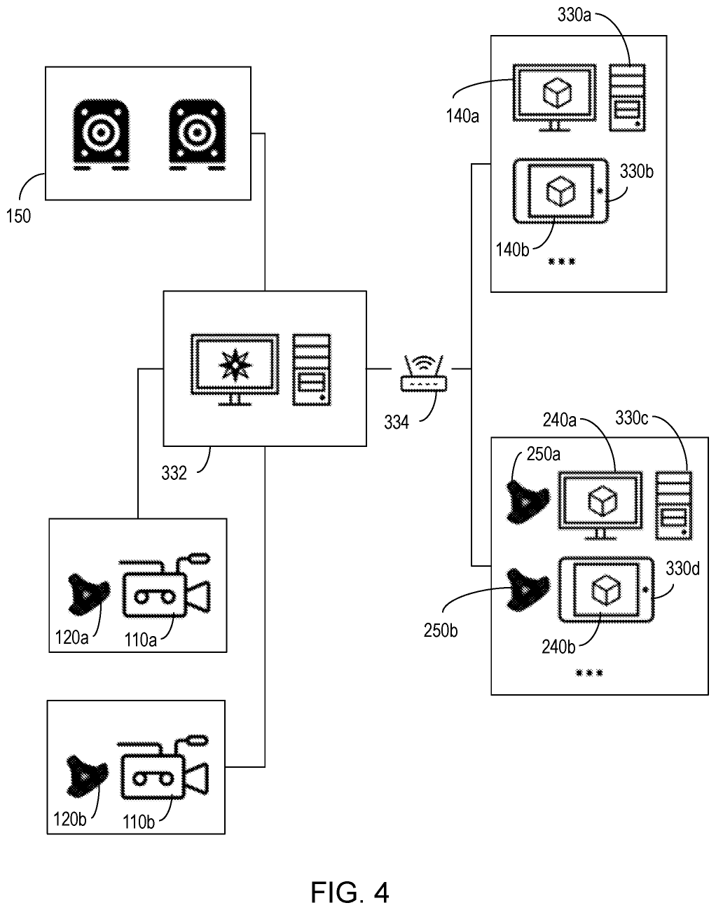

The tracking master computing device 332 is configured to transmit, over the network 334, video camera position and orientation data describing a position and orientation of any video cameras 110 to each visualisation computing device that generates three-dimensional projection images for display on an associated display screen. The tracking master computing device 332 may transmit video camera position and orientation data describing a position and orientation of all video cameras 110, or only video camera position and orientation data describing a position and orientation of an active video camera 110 (as described further below with reference to FIG. 4). In the example shown in FIG. 3A, the tracking master computing device 332 transmits the video camera position and orientation data (received from the video camera tracking device 120 associated with the video camera 110) over the network 334 to the visualisation computing device 330 (which generates three-dimensional projection images for display on the display screen 240).

The tracking master computing device 332 may also transmit display screen position and orientation data describing a position and orientation of any display screens (i.e. the display screen 240 in the example of FIG. 3A) to the visualisation computing devices that generate the three-dimensional projection images for display on associated display screens (i.e. to the visualisation computing device 330 in the example of FIG. 3A).

There are a number of options by which the video recording system 300 may allow a three-dimensional projection image to be displayed on the display screen 240, which will be described with reference to the example of FIG. 3A.

Firstly, the tracking master computing device 332 may transmit only video camera position and orientation data describing a position and orientation of the video camera 110 to the visualisation computing device 330. In this case, the visualisation computing device 330 may use the position and orientation of its associated display screen 240 (e.g. as determined by the display screen tracking device 250) to determine a position and orientation of the video camera 110 relative to the position and orientation of the display screen 240, and to generate the three-dimensional projection image based on the relative position and orientation.

Secondly, the tracking master computing device 332 may transmit both the video camera position and orientation data describing a position and orientation of the video camera 110 and the display screen position and orientation data describing a position and orientation of the display screen 240 to the visualisation computing device 330. In this case, the visualisation computing device 330 may use the information received from the tracking master computing device 332 to determine a position and orientation of the video camera 110 relative to the position and orientation of the display screen 240, and to generate the three-dimensional projection image based on the relative position and orientation.

Thirdly, the tracking master computing device 332 may determine a position and orientation of the video camera 110 relative to the position and orientation of the display screen 240, in which case the video camera position and orientation data transmitted by the tracking master computing device 332 is relative position and orientation data describing a position and orientation of the video camera 110 relative to the position and orientation of the display screen 240. In this case, the visualisation computing device 330 may generate the three-dimensional projection image based on the relative position and orientation data received from the tracking master computing device 332.

By implementing a dedicated tracking master computing device 332 for providing video camera position and orientation data, a more scalable video recording system 300 is provided. In general, tracking devices are not configured to send data to multiple devices. Implementing the tracking master computing device 332 allows video camera position and orientation data to be transmitted to multiple visualisation computing devices 300, thereby increasing the number of display screens 240 that can be implemented in the video recording system 240, and consequently providing a more scalable video recording system 300.

In the second scenario above, video camera position and orientation data and display screen position and orientation data is transmitted from the tracking master computing device 332 to the visualisation computing device 330. In addition, in the third scenario above, relative position and orientation data describing a position and orientation of the video camera 110 relative to the position and orientation of the display screen 240 is transmitted from the tracking master computing device 332 to the visualisation computing device 330. In each of these cases, no data is received directly from the tracking devices at the visualisation computing device 330. This allows the visualisation computing device 330 to display three-dimensional projection images from the viewpoint of the movable video camera 110, while being agnostic to the tracking technologies used to track the position and orientation of the video camera 110 and display screen 240, because it does not need to interact with the tracking devices. Instead, the visualisation computing device 330 only needs to receive a network message with video camera position and orientation information (either absolute position and orientation data, as in the second scenario, or relative position and orientation data, as in the third scenario), from which it can generate the three-dimensional projection image for display on its associated display screen 240. This increases the amount of display screens and type of display screens that can be used in the video recording system 330.

FIG. 3B is a schematic diagram showing the modules of the visualisation computing device 330 and the modules of the tracking master computing device 332. As shown in FIG. 3B, the visualisation computing device 330 comprises a calibration module 362, a projection module 364, a content module 368, and a networking module 370. The tracking master computing device 332 comprises a tracking module 380, a calibration module 382, a real-time layout view module 386, and a networking module 390.

The calibration module 362 allows data relating to the display screen 240 to be input during setup of the video recording system 300. For example, the calibration module 362 may receive data identifying the size of the display screen 240, the position and orientation of the display screen 240 within the three-dimensional environment, a unique identifier of the display screen 240, and an indicator that indicates whether the display screen 240 is static (as with the example above) or movable (as with the example of FIG. 3A). This data may be input to the calibration module 362 (e.g. via a user interface) or received over a network.

The projection module 364 computes a projection matrix used to render the three-dimensional projection image 242, in the same way as the projection module 164 of the tracking and visualisation computing device 130 described with reference to FIG. 1B. Likewise, the content module 368 allows three-dimensional content items to be generated for display on the display screen 240, in the same way as the content module 168 described above.

The networking module 370 allows the visualisation computing device 330 to receive data from the tracking master computing device 332. Specifically, the networking module 370 receives the video camera position and orientation data (i.e. absolute or relative position and orientation data for the video camera 110) from the tracking master computing device 332 over the network 334. In one example, the networking module 370 receives the tracking data via a communications protocol such as UDP. The networking module 370 also optionally receives display screen position and orientation data, either from the tracking master computing device 332, or directly from the display screen tracking device 250 that tracks the position and orientation of the display screen 240 associated with the visualisation computing device 330.

Turning, now, to the modules of the tracking master computing device 332, the tracking module 380 receives the position and orientation data from the tracked devices. Accordingly, in the example of FIG. 3A, the tracking module 380 receives, from the video camera tracking device 120, video camera position and orientation data describing a position and orientation of the video camera 110, and optionally receives, from the display screen tracking device 250, display screen position and orientation data describing a position and orientation of the display screen 240.

The calibration module 382 allows for calibration of the video recording system 300. For example, the calibration module 382 allows for the position and orientation of any static display screens (not shown in FIG. 3A) to be input during setup of the video recording system 300. The position and orientation of static display screens may be input relative to origin coordinates of the video recording system 300.

The real-time layout view module 386 provides a view of the video recording system 300 in the same way as the real-time layout view module 166 of the tracking and visualisation computing device 130 described with reference to FIG. 1B.

The networking module 390 allows the tracking master computing device 332 to send data to the visualisation computing device 330. Specifically, the networking module 390 transmits the absolute or relative video camera position and orientation data and optionally the display screen position and orientation data to the networking module 370 of the visualisation computing device 330 over the network 334 (e.g. via a communications protocol such as UDP).

FIG. 4 is a schematic diagram of a video recording system 400 according to a fourth example. The video recording system 400 of the fourth example includes the light stations 150 described above for the video recording system 100 of the first example, along with the tracking master computing device 332 described above for the video recording system 300 of the third example.

The video recording system 400 of the fourth example includes a plurality of video cameras 110 (shown in FIG. 4 as a first video camera 110a and a second video camera 110b). The position and orientation of each video camera 110 is tracked using an associated video camera tracking device 120, meaning that the position and orientation of the first video camera 110a is tracked using a first video camera tracking device 120a, and the position and orientation of the second video camera 110b is tracked using a second video camera tracking device 120b. Specifically, the first video camera tracking device 120a provides position and orientation data indicative of a viewpoint of the first video camera 110a, while the second video camera tracking device 120b provides position and orientation data indicative of a viewpoint of the second video camera 110b.

The video recording system 400 also includes a plurality of display screens 140, 240. Specifically, the plurality of display screens 140, 240 includes a plurality of static display screens 140 (shown in FIG. 4 as a first static display screen 140a and a second static display screen 140b), along with a plurality of movable display screens 240 (shown in FIG. 4 as a first movable display screen 240a and a second movable display screen 240b). In the example shown in FIG. 4, the first static display screen 140a is display screen of a static PC such as a desktop PC and the first movable display screen 240a is a display screen of a portable PC such as a laptop. The second static display screen 140b is a display screen of a tablet computer that is used in a fixed position and orientation on set, while the second movable display screen 240b is a display screen of a tablet computer that is moved around on set.

Each display screen 140, 240 is configured to display a three-dimensional projection image generated by a visualisation computing device 330 associated with that display screen 140, 240. In the example shown in FIG. 4, a first visualisation computing device 330a (e.g. desktop PC) is associated with the first static display screen 140a, a second visualisation computing device 330b (e.g. tablet) is associated with the second static display screen 140b, a third visualisation computing device 330c (e.g. laptop) is associated with the first movable display screen 240a, and a fourth visualisation computing device 330d (e.g. tablet) is associated with the second movable display screen 240b.

One or more of the display screens 140, 240 may be within a field of view of each video camera 110. In one example, all of the display screens 140, 240 are within a field of view of the first video camera 110a and/or within a field of view of the second video camera 110b. One or more of the display screens 140, 240 may be interactive. In one example, all of the display screens 140, 240 are interactive display screens.

The position and orientation of each movable display screen 240 is tracked using an associated display screen tracking device 250, meaning that the position and orientation of the first movable display screen 240a is tracked using a first display screen tracking device 250a, and the position and orientation of the second movable display screen 240b is tracked using a second display screen tracking device 250b.

As described above for the video recording system 300 of the third example, the tracking master computing device 332 receives video camera position and orientation data for all tracked video cameras (i.e. the first video camera 110a, the second video camera 110b in the example shown in FIG. 4), and optionally receives display screen position and orientation data for all tracked display screens (i.e. the first movable display screen 240a and the second movable display screen 240b in the example shown in FIG. 4). The tracking master computing device 332 may generate consolidated position and orientation data describing the positions and orientations of all tracked devices.

The tracking master computing device 332 transmits the video camera position and orientation data to all visualisation computing devices 330 associated with the display screens 140, 240. That is, the tracking master computing device 332 sends the video camera position and orientation data to the first visualisation computing device 330a, second visualisation computing device 330b, third visualisation computing device 330c and fourth visualisation computing device 330d. As described above, the tracking master computing device 332 may transmit (e.g. broadcast) the video camera position and orientation data for all video cameras 110 to all visualisation computing devices 330 (for example, where an indication of the active video camera 110 is received at the visualisation computing devices 330), or may transmit only the video camera position and orientation data for an active video camera 110 to all visualisation computing devices 330 (for example, where an indication of the active video camera 110 is received at the tracking master computing device 332). In this context, “all visualisation computing devices 330” refers to all visualisation computing devices 330 associated with display screens 140, 240 within the field of view of the active video camera 110. It will be appreciated that if a display screen 140, 240 is outside the field of view of the active video camera 110, then no three-dimensional projection image needs to be displayed on that display screen 140, 240.

The three scenarios discussed above with reference to FIG. 3A are also applicable to the video recording system 400 of FIG. 4. That is, the tracking master computing device 332 may transmit only video camera position and orientation data, both video camera position and orientation data and display screen position and orientation data, or relative video camera position and orientation data, depending on whether any display screen position and orientation data is received at the visualisation computing devices 330 directly from any display screen tracking devices 250 that track the position and orientation of their associated display screens 240.

Each visualisation computing device 330 is configured to generate, for display on its associated display screen 140, 240, a three-dimensional projection image based on the position and orientation data of the tracked devices. More specifically, each of the visualisation computing devices 330 generates a three-dimensional projection image based on the position and orientation data received for the first video camera 110a or the second video camera 110b (depending on which video camera 110 is actively recording, as described further below). In addition, the three-dimensional projection images generated by the third visualisation computing device 330c and the fourth visualisation computing device 330d are also based on the position and orientation data received for, respectively, the first movable display screen 240a and the second movable display screen 240b.

In one example, one or more of the display screens 140, 240 displays visual content that is independent of the visual content displayed on the other display screens 140, 240. For example, the first static display screen 140a may display a first three-dimensional projection image showing a first three-dimensional content item from the viewpoint of a video camera 110, while the second movable display screen 240b may display a second three-dimensional projection image showing a second, independent three-dimensional content item from the viewpoint of the video camera 110. In an alternative example, one or more of the display screens 140, 240 may display visual content that is linked to the visual content displayed on the other display screens 140, 240. For example, the first static display screen 140a may display a first three-dimensional projection image showing a first three-dimensional content item, while the second movable display screen 240b displays a second three-dimensional projection image showing a second three-dimensional content item that is associated with the first three-dimensional content item. In this context, “associated with” indicates that if a user interacts with the first three-dimensional content item or the second three-dimensional content item, then the display of both three-dimensional projection images is adjusted by the processors of the visualisation computing devices 330 associated with the display screens 140, 240. Alternatively, a three-dimensional content item may be displayed across multiple display screens 140, 240. As a further alternative, one or more of the display screens 140, 240 may show the same three-dimensional content item, such that a first three-dimensional projection image is used to show a three-dimensional content item from a viewpoint of a video camera 110 on a first display screen 140, 240, while a second three-dimensional projection image is used to show the three-dimensional content item from the viewpoint of the video camera 110 on a second display screen 140, 240.

As mentioned above, the video recording system 400 includes the first video camera 110a and the second video camera 110b. It will be appreciated that the display of one or more three-dimensional content items on the display screens 140, 240 will vary depending on whether the one or more three-dimensional content items are being shown from the viewpoint of the first video camera 110a or the second video camera 110b. An indicator may therefore be used to indicate which of the video cameras 110 is actively recording. For example, the indicator may be provided to the tracking master computing device 332, which may broadcast the indicator to the display screens 140, 240. Alternatively, the tracking master computing device 332 may use the indicator to transmit only the video camera position and orientation data associated with the active video camera 110. As a further alternative, the indicator may be provided to each of the visualisation computing devices 330.

The value of the indicator may change in response to a different video camera 110 being used to record video of a scene. For pre-recorded video content such as films and television programmes, the time at which recording switches from the first video camera 110a to the second video camera 110b may be known in advance, and therefore may be provided in advance to the tracking master computing device 332 or to the visualisation computing devices 330 associated with the display screens 140, 240. For a live broadcast, the indicator may be provided a predetermined number of frames in advance of the change in video camera, in order to account for any delay in generating the updated three-dimensional projection image from the viewpoint of the new video camera. The delay in generating the updated three-dimensional projection image may be measured during calibration of the video recording system 400 in order to determine how far in advance (i.e. how many frames in advance) an indicator needs to be provided in the event of a change in video camera.

In response to receiving an indication that its associated display screen 140, 240 is to be viewed from the viewpoint of a different video camera 110, the one or more processors of a visualisation computing device 330 generate an updated three-dimensional projection image for display on the display screen 140, 240. The updated three-dimensional projection image shows the three-dimensional content item from the viewpoint of the different video camera. For example, an initial three-dimensional projection image may show the three-dimensional content item from the viewpoint of the first video camera 110a, while the updated three-dimensional projection image shows the three-dimensional content item from the viewpoint of the second video camera 110b.

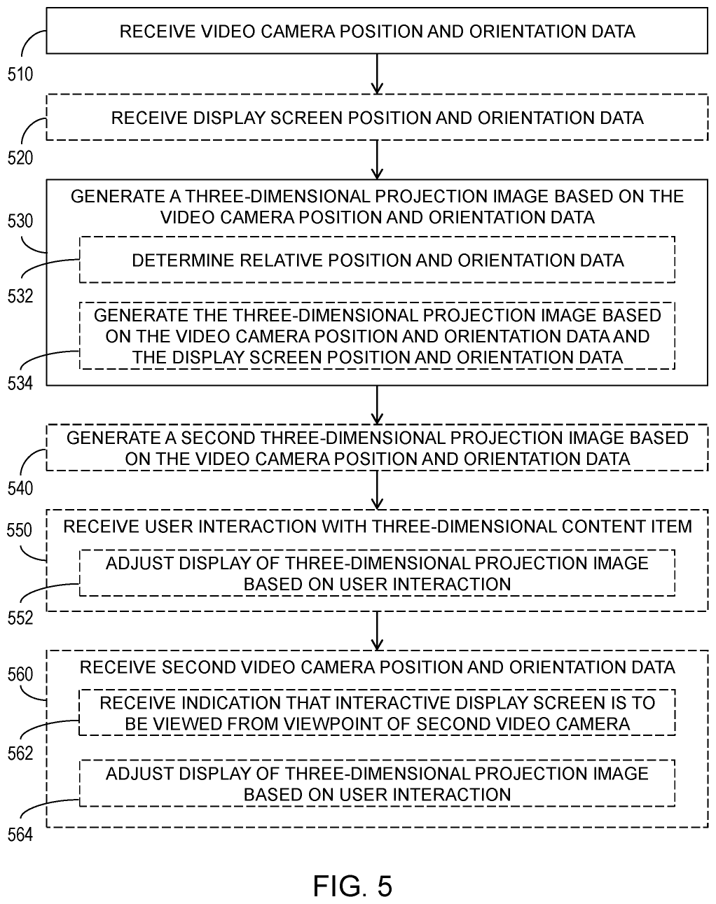

FIG. 5 is a flowchart of a method 500 of generating visual content according to the examples described above. The method 500 may be implemented by the tracking and visualisation computing device 130 described above, or by the visualisation computing device 330 described above. The order of the processes described below is not intended to be limiting, and the skilled person will appreciate that the processes and sub-processes of the method 500 may be carried out in a different order to that described below and shown in FIG. 5. Optional processes and sub-processes are shown in FIG. 5 in dashed boxes.

At 510, video camera position and orientation data is received. The video camera position and orientation data is indicative of a viewpoint of a video camera. The video camera position and orientation data may be absolute video camera position and orientation data, or may be relative video camera position and orientation data indicating a position and orientation of the video camera relative to a position and orientation of an interactive display screen.

Optionally, at 520, display screen position and orientation data is received. The display screen position and orientation data is indicative of a position and orientation of the interactive display screen.

At 530, a three-dimensional projection image is generated based on the video camera position and orientation data. The three-dimensional projection image is generated for display on an interactive display screen that is within a field of view of the video camera. The three-dimensional projection image is generated at 530 so that it shows a three-dimensional content item from the viewpoint of the video camera.

The process of generating the three-dimensional projection image at 530 may comprise optional sub-process 532 and/or optional sub-process 534. At 532, relative position and orientation data is determined (i.e. if it is not received at 510). The relative position and orientation data is indicative of a position and orientation of the video camera relative to a position and orientation of the interactive display screen. At 534, the three-dimensional projection image is generated based on the video camera position and orientation data and the display screen position and orientation data (if display screen position and orientation data is received at 520).

Optionally, at 540, a second three-dimensional projection image is generated based on the video camera position and orientation data. The second three-dimensional projection image is generated for display on a second display screen that is within the field of view of the video camera. The second three-dimensional projection image may be generated so that it shows a second three-dimensional content item from the viewpoint of the video camera, or so that it shows the same three-dimensional content item as the interactive display screen. The second display screen may also be interactive. The second three-dimensional projection image may also be generated based on display screen position and orientation data describing a position and orientation of the second display screen.

Optionally, at 550, a user interaction with the three-dimensional content item is received. If a user interaction is received at 550, then at 552, the display of the three-dimensional projection image is adjusted based on the user interaction received at 550. For example, adjustment of the three-dimensional projection image may include rendering a new three-dimensional projection image showing an adjusted view of the three-dimensional content item, or may include rendering a new three-dimensional projection image showing a different three-dimensional content item.

Optionally, at 560, second video camera position and orientation data is received. The second video camera position and orientation data is indicative of a second viewpoint that is different to the first viewpoint. The second video camera position and orientation data received at 560 may be indicative of an updated viewpoint of the video camera. Alternatively, the second video camera position and orientation data received at 560 may be indicative of a viewpoint of a second video camera that is different to the first video camera, where the interactive display screen is also within the field of view of the second video camera.

If second video camera position and orientation data is received at 560, then at 564, an updated three-dimensional projection image is generated. The updated three-dimensional projection image is generated for display on the interactive display screen. The updated three-dimensional projection image is generated at 564 so that it shows the three-dimensional content item from the second viewpoint.

If the second video camera position and orientation data received at 560 is indicative of an updated viewpoint of the video camera, then the method 500 proceeds directly from 560 to 564. On the other hand, if the second video camera position and orientation data received at 560 is indicative of a viewpoint of a second video camera, then the method may proceed to 562. At 562, an indication that the interactive display screen is to be viewed from the viewpoint of the second video camera is received. Then, at 564, the three-dimensional projection image may be generated in response to receiving the indication at 562.

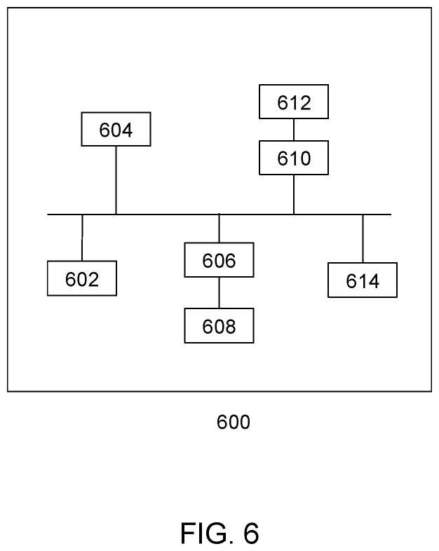

Turning finally to FIG. 6, shown is a schematic and simplified representation of a computer apparatus 600 which can be used to perform the methods described herein, either alone, in combination with other computer apparatuses or as part of a “cloud” computing arrangement. For example, the computer apparatus 600 may be indicative of the architecture of the tracking and visualisation computing device 130, the tracking master computing device 332 and/or the visualisation computing device 330 described above.

The computer apparatus 600 comprises various data processing resources such as a processor 602 (in particular a hardware processor) coupled to a central bus structure. Also connected to the bus structure are further data processing resources such as memory 604. A display adapter 606 connects a display device 608 to the bus structure. The display device 608 may be, for example, the static display screen 140 described above or the movable display screen 240 described above. Alternatively, the display device 608 may be a separate device, such as a device used to receive a user input (e.g. to the calibration modules 162, 362, 382 described above), and/or a device used to show a view of a video recording system (e.g. as provided by the real-time layout view modules 166, 386 described above).

One or more user-input device adapters 610 connect a user-input device 612, such as a keyboard, a touchscreen, a microphone and/or a mouse to the bus structure. One or more communications adapters 614 are also connected to the bus structure to provide connections to other computer systems 600 and other networks (e.g. to the network modules 370, 390 described above).

In operation, the processor 602 of computer system 600 executes a computer program comprising computer-executable instructions that may be stored in memory 604. When executed, the computer-executable instructions may cause the computer system 600 to perform one or more of the methods described herein (e.g. the method 500 described above). The results of the processing performed may be displayed to a user via the display adapter 606 and display device 608. User inputs for controlling the operation of the computer system 600 may be received via the user-input device adapters 610 from the user-input devices 612. The user-input devices 612 may also receive user interactions with content displayed via the display device 608, as described above.

It will be apparent that some features of computer system 600 shown in FIG. 6 may be absent in certain cases. For example, one or more of the plurality of computer apparatuses 600 may have no need for the display adapter 606 or display device 608. This may be the case, for example, for particular server-side computer apparatuses 600 which are used only for their processing capabilities and do not need to display information to users. Similarly, user input device adapter 610 and user input device 612 may not be required. In its simplest form, computer apparatus 600 comprises processor 602 and memory 604.

Variations or modifications to the systems and methods described herein are set out in the following paragraphs.

Although the above examples are described with reference to receiving position and orientation data of tracked devices (e.g. video cameras and display screens), it is not necessary for both position and orientation data to be received. In some examples, the position of tracked devices (e.g. video cameras) may be fixed, but the tracked devices may be movable to different orientations at that fixed position. In such a case, the three-dimensional projection image may be generated based on orientation data (and not position data) of the tracked devices. In other examples, the orientation of tracked devices (e.g. video cameras) may be fixed, but the tracked devices may be movable to different positions while maintaining that fixed orientation. In such a case, the three-dimensional projection image may be generated based on position data (and not orientation data) of the tracked devices.

The above examples all include a movable video camera. It will be appreciated, however, that the implementations described above are also applicable to video recording systems in which the video camera is static, and one or more display screens are movable. In this case, the position and orientation data of the static video camera may be known in advance and may, for example, be received by way of user input.

In addition, the above examples include visualisation computing devices that generate three-dimensional projection images for display on an associated display screen. It will be appreciated that a one-to-one relationship between visualisation computing devices and display screens is not required. For example, in some cases, a single visualisation computing device may generate three-dimensional projection images for multiple display screens. In other cases, the rendering processing may be distributed across multiple devices in order to generate a three-dimensional projection image for a single display screen. A distributed processing architecture may also be implemented in order to provide the functionality of the tracking master computing device described with reference to FIGS. 3A to 4.

The described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

Set out below are the following numbered clauses, which describe feature combinations that are useful for understanding the present disclosure:

1. A system for generating visual content, the system comprising:
a video camera;
an interactive display screen configured to display visual content, wherein the interactive display screen is within a field of view of the video camera; and
one or more processors configured to:
   receive video camera position and/or orientation data indicative of a viewpoint of the video camera; and
   generate, for display on the interactive display screen, a three-dimensional projection image based on the video camera position and/or orientation data, such that the three-dimensional projection image shows a three-dimensional content item from the viewpoint of the video camera.

2. A system according to clause 1, wherein generating the three-dimensional projection image based on the video camera position and/or orientation data comprises determining relative position and/or orientation data indicative of a position and/or an orientation of the video camera relative to a position and/or an orientation of the interactive display screen.

3. A system according to clause 1 or clause 2, further comprising a video camera tracking module configured to track a position and/or an orientation of the video camera, wherein the one or more processors receive the video camera position and/or orientation data from the video camera tracking module.

4. A system according to any of clauses 1 to 3, wherein the viewpoint is a first viewpoint and the video camera position and/or orientation data is first video camera position and/or orientation data, and wherein the one or more processors are further configured to:
receive second video camera position and/or orientation data indicative of a second viewpoint different to the first viewpoint; and
generate, for display on the interactive display screen, an updated three-dimensional projection image based on the second video camera position and/or orientation data, such that the updated three-dimensional projection image shows the three-dimensional content item from the second viewpoint.

5. A system according to clause 4, wherein the second video camera position and/or orientation data is indicative of an updated viewpoint of the video camera.

6. A system according to clause 4, wherein:
the video camera is a first video camera;
the system further comprises a second video camera different to the first video camera, wherein the interactive display screen is within a field of view of the second video camera;
the second video camera position and/or orientation data is indicative of a viewpoint of the second video camera; and
the one or more processors are configured to generate the updated three-dimensional projection image in response to receiving an indication that the interactive display screen is to be viewed from the viewpoint of the second video camera.

7. A system according to any of clauses 1 to 6, wherein:
the interactive display screen is a first display screen, and the three-dimensional projection image is a first three-dimensional projection image;
the system further comprises a second display screen configured to display visual content, wherein the second display screen is within the field of view of the video camera; and
wherein the one or more processors are further configured to generate, for display on the second display screen, a second three-dimensional projection image based on the video camera position and/or orientation data.

8. A system according to any of clauses 1 to 7, wherein the one or more processors are further configured to:
receive display screen position and/or orientation data indicative of a position and/or an orientation of the interactive display screen; and
generate the three-dimensional projection image based on the video camera position and/or orientation data and the display screen position and/or orientation data.

9. A system according to clause 8, further comprising a display screen tracking module configured to track the position and/or the orientation of the interactive display screen, wherein the one or more processors receive the display screen position and/or orientation data from the display screen tracking module.

10. A system according to any of clauses 1 to 9, further comprising:
a first computing device comprising a first one of the one or more processors, wherein the first one of the one or more processors is configured to receive the video camera position and/or orientation data; and
a second computing device comprising a second one of the one or more processors, wherein the second computing device is in communication with the first computing device over a network, and wherein the second one of the one of more processors is configured to:
   receive the video camera position and/or orientation data from the first computing device over the network; and
   generate, for display on the interactive display screen, the three-dimensional projection image.

11. A system according to any of clauses 1 to 10, wherein the one or more processors are configured to:
receive a user interaction with the three-dimensional content item; and
adjust the display of the three-dimensional projection image based on the user interaction.

12. A method of generating visual content, the method comprising:
receiving video camera position and/or orientation data indicative of a viewpoint of a video camera; and
generating, for display on an interactive display screen within a field of view of the video camera, a three-dimensional projection image based on the video camera position and/or orientation data, such that the three-dimensional projection image shows a three-dimensional content item from the viewpoint of the video camera.

13. A method according to clause 12, wherein generating the three-dimensional projection image based on the video camera position and/or orientation data comprises determining relative position and/or orientation data indicative of a position and/or an orientation of the video camera relative to a position and/or an orientation of the interactive display screen.

14. A method according to clause 12 or clause 13, wherein the viewpoint is a first viewpoint and the video camera position and/or orientation data is first video camera position and/or orientation data, and wherein the method further comprises:
receiving second video camera position and/or orientation data indicative of a second viewpoint different to the first viewpoint; and
generating, for display on the interactive display screen, an updated three-dimensional projection image based on the second video camera position and/or orientation data, such that the updated three-dimensional projection image shows the three-dimensional content item from the second viewpoint.

15. A method according to clause 14, wherein the second video camera position and/or orientation data is indicative of an updated viewpoint of the video camera.

16. A method according to clause 14, wherein:
the video camera is a first video camera;
the second video camera position and/or orientation data is indicative of a viewpoint of a second video camera different to the first video camera, wherein the interactive display screen is within a field of view of the second video camera; and
the updated three-dimensional projection image is generated in response to receiving an indication that the interactive display screen is to be viewed from the viewpoint of the second video camera.

17. A method according to any of clauses 12 to 16, wherein:
the interactive display screen is a first display screen, and the three-dimensional projection image is a first three-dimensional projection image; and
the method further comprises generating, for display on a second display screen within the field of view of the video camera, a second three-dimensional projection image based on the video camera position and/or orientation data.

18. A method according to any of clauses 12 to 17, further comprising:
receiving display screen position and/or orientation data indicative of a position and/or an orientation of the interactive display screen; and
generating the three-dimensional projection image based on the video camera position and/or orientation data and the display screen position and/or orientation data.

19. A method according to any of clauses 12 to 18, further comprising:
receiving a user interaction with the three-dimensional content item; and
adjusting the display of the three-dimensional projection image based on the user interaction.

20. A computer-readable medium comprising instructions which, when executed by one or more processors of a computing device, cause the computing device to carry out the method of any of clauses 12 to 19.

1. A system for generating visual content, the system comprising:
a video camera;
an interactive display screen configured to display visual content, wherein the interactive display screen is within a field of view of the video camera; and
one or more processors configured to:
receive video camera position and/or orientation data indicative of a viewpoint of the video camera; and
generate, for display on the interactive display screen, a three-dimensional projection image based on the video camera position and/or orientation data, such that the three-dimensional projection image shows a three-dimensional content item from the viewpoint of the video camera.

2. A system according to claim 1, wherein generating the three-dimensional projection image based on the video camera position and/or orientation data comprises determining relative position and/or orientation data indicative of a position and/or an orientation of the video camera relative to a position and/or an orientation of the interactive display screen.

3. A system according to claim 1, further comprising a video camera tracking module configured to track a position and/or an orientation of the video camera, wherein the one or more processors receive the video camera position and/or orientation data from the video camera tracking module.

4. A system according to claim 1, wherein the viewpoint is a first viewpoint and the video camera position and/or orientation data is first video camera position and/or orientation data, and wherein the one or more processors are further configured to:
receive second video camera position and/or orientation data indicative of a second viewpoint different to the first viewpoint; and
generate, for display on the interactive display screen, an updated three-dimensional projection image based on the second video camera position and/or orientation data, such that the updated three-dimensional projection image shows the three-dimensional content item from the second viewpoint.

5. A system according to claim 4, wherein the second video camera position and/or orientation data is indicative of an updated viewpoint of the video camera.

6. A system according to claim 4, wherein:
the video camera is a first video camera;
the system further comprises a second video camera different to the first video camera, wherein the interactive display screen is within a field of view of the second video camera;
the second video camera position and/or orientation data is indicative of a viewpoint of the second video camera; and
the one or more processors are configured to generate the updated three-dimensional projection image in response to receiving an indication that the interactive display screen is to be viewed from the viewpoint of the second video camera.

7. A system according to claim 1, wherein:
the interactive display screen is a first display screen, and the three-dimensional projection image is a first three-dimensional projection image;
the system further comprises a second display screen configured to display visual content, wherein the second display screen is within the field of view of the video camera; and
wherein the one or more processors are further configured to generate, for display on the second display screen, a second three-dimensional projection image based on the video camera position and/or orientation data.

8. A system according to claim 1, wherein the one or more processors are further configured to:
receive display screen position and/or orientation data indicative of a position and/or an orientation of the interactive display screen; and
generate the three-dimensional projection image based on the video camera position and/or orientation data and the display screen position and/or orientation data.

9. A system according to claim 9, further comprising a display screen tracking module configured to track the position and/or the orientation of the interactive display screen, wherein the one or more processors receive the display screen position and/or orientation data from the display screen tracking module.

10. A system according to claim 1, further comprising:
a first computing device comprising a first one of the one or more processors, wherein the first one of the one or more processors is configured to receive the video camera position and/or orientation data; and
a second computing device comprising a second one of the one or more processors, wherein the second computing device is in communication with the first computing device over a network, and wherein the second one of the one of more processors is configured to:
receive the video camera position and/or orientation data from the first computing device over the network; and
generate, for display on the interactive display screen, the three-dimensional projection image.

11. A system according to claim 1, wherein the one or more processors are configured to:
receive a user interaction with the three-dimensional content item; and
adjust the display of the three-dimensional projection image based on the user interaction.

12. A method of generating visual content, the method comprising:
receiving video camera position and/or orientation data indicative of a viewpoint of a video camera; and
generating, for display on an interactive display screen within a field of view of the video camera, a three-dimensional projection image based on the video camera position and/or orientation data, such that the three-dimensional projection image shows a three-dimensional content item from the viewpoint of the video camera.

13. A method according to claim 12, wherein generating the three-dimensional projection image based on the video camera position and/or orientation data comprises determining relative position and/or orientation data indicative of a position and/or an orientation of the video camera relative to a position and/or an orientation of the interactive display screen.

14. A method according to claim 12, wherein the viewpoint is a first viewpoint and the video camera position and/or orientation data is first video camera position and/or orientation data, and wherein the method further comprises:
receiving second video camera position and/or orientation data indicative of a second viewpoint different to the first viewpoint; and
generating, for display on the interactive display screen, an updated three-dimensional projection image based on the second video camera position and/or orientation data, such that the updated three-dimensional projection image shows the three-dimensional content item from the second viewpoint.

15. A method according to claim 14, wherein the second video camera position and/or orientation data is indicative of an updated viewpoint of the video camera.

16. A method according to claim 14, wherein:
the video camera is a first video camera;
the second video camera position and/or orientation data is indicative of a viewpoint of a second video camera different to the first video camera, wherein the interactive display screen is within a field of view of the second video camera; and
the updated three-dimensional projection image is generated in response to receiving an indication that the interactive display screen is to be viewed from the viewpoint of the second video camera.

17. A method according to claim 12, wherein:
the interactive display screen is a first display screen, and the three-dimensional projection image is a first three-dimensional projection image; and
the method further comprises generating, for display on a second display screen within the field of view of the video camera, a second three-dimensional projection image based on the video camera position and/or orientation data.

18. A method according to claim 12, further comprising:
receiving display screen position and/or orientation data indicative of a position and/or an orientation of the interactive display screen; and
generating the three-dimensional projection image based on the video camera position and/or orientation data and the display screen position and/or orientation data.

19. A method according to claim 12, further comprising:
receiving a user interaction with the three-dimensional content item; and
adjusting the display of the three-dimensional projection image based on the user interaction.

20. A non-transitory computer-readable medium comprising instructions which, when executed by one or more processors of a computing device, cause the computing device to carry out the method of claim 12.
